(19) United States
(12) Patent Application Publication
(10) Pub. No.: US 2026/0302155 A1
(43) Pub. Date: Oct. 1, 2026

(54) ADAPTER AND KIT FOR JOINING A TOOL TO A THREADED POLE

(71) Applicant: EZ Smart Co., Omaha, NE (US)

(72) Inventors: Mark J. RAMSEY, Omaha, NE (US); Mark C. RAMSEY, Omaha, NE (US)

(73) Assignee: EZ Smart Co., Omaha, NE (US)

(21) Appl. No.: 19/288,005

(22) Filed: Aug. 1, 2025

Related U.S. Application Data
(60) Provisional application No. 63/714,930, filed on Nov. 1, 2024.

(51) Int. Cl. H01K 3/32; B25G 3/26; B25G 3/30

(52) U.S. Cl. CPC H01K 3/32; B25G 3/26; B25G 3/30

(57) ABSTRACT

An adapter for joining a tool to a threaded pole includes a body, a lock mechanism, and an attachment lock. The body preferably having an internally threaded end and an attachment end opposite the internally threaded end. The lock mechanism enters the internally threaded end. The attachment lock being located at the attachment end and configured to interact with the removal tool when the removal tool is attached to the attachment end.

### CROSS REFERENCES AND PRIORITIES

This application claims priority from U.S. Provisional Application No. 63/714,930 filed on 1 Nov. 2024, the teachings of which are incorporated vy reference herein in their entirety.

### BACKGROUND

Tools used to grip an object during installation or removal are well known in the art. Often these tools utilize a pair of opposing fingers or jaws—such as in a pair of pliers—to grip the object. Other tools may utilize frictional forces applied around the object and/or a suction force to grip the object during installation or removal.

Existing tools suffer from a number of defects, particularly when the object being installed or removed is at a height greater than that which can be reached by a human arm. In such instances, a ladder, stool, or similar mechanism may be required for the installer/remover to reach the object being installed or removed with the removal tool. This poses serious health and safety risks as the installer/remover may lose their balance and fall from the ladder or stool while attempting to install or remove the object.

A number of solutions have been developed for installing or removing objects at such heights. The most well-known of which are handicapped “grabber” tools which include an extended rod with a gripping finger on one end connected by a string, cable or the like to a pivotable handle at the opposing end. When a user pivots the handle, the gripping finger pivots towards the end of the rod allowing the rod and the gripping finger to apply a force around the object.

In practice, these “grabber” tools are unsuitable for many applications. In particular the installation or removal of a light bulb which requires delicate handling to avoid breaking the light bulb while it is being rotated in and/or out of a light socket.

The need exists, therefore, for an improved tool for installing and removing objects at heights greater than that which can be reached by a human arm and which is capable of delicately gripping fragile objects such as light bulbs.

### SUMMARY

This specification discloses an adapter for joining a tool to a threaded pole. A bulb removal tool is an exemplary tool. It discloses that the tool will have a tool stud and a tool stud hole.

It is further disclosed that the adapter may have a body having an internally threaded end and an attachment end having a center hole opposite the internally threaded end. The adapter will further have a lock mechanism entering the internally threaded end to lock the adapter to the pole. There will also be an attachment lock configured to interact with the tool stud and the attachment end when the tool stud is inserted into the center hole in order to lock the tool to the adapter.

It is further disclosed that the attachment end may comprises a lighting element electrically connected to a power supply with the lighting element configured to turn on when a circuit between the lighting element and the power supply is closed by a switch.

The specification also discloses that the adapter may further comprise a locking hole passing through the center hole with the attachment lock being a pin configured to pass into the locking hole, a depressible button configured to pass into at least a portion of the locking hole, a spring interlock configured to pass into at least a portion of the locking hole, or a magnet and pin system configured to pass into at least a portion of the locking hole.

To allow for the tool to be removed from a light bulb, it is further disclosed that the adapter may have a spool located between the internally threaded end and the attachment end, and a string having a string first end configured to connect to a portion of the tool and a string second end.

In some embodiments, the internally threaded end of the body may includes a first flat outer surface and a second flat outer surface with the first flat outer surface opposing the second flat outer surface in order to better tighten the adapter to the threaded pole.

To keep the adapter fixed on the pole, the lock mechanism may comprise a lock screw configured to pass into a threaded hole in a body sidewall at the internally threaded end.

It is further disclosed that that these parts may be part of a kit for attaching a tool to a threaded pole. This kit is disclosed as comprising the adapter, the lock mechanism, the attachment lock, at least one tool, and optionally a thread convertor

It is further disclosed that the adapter in the kit may further comprise the lighting element.

It is also disclosed that the tool in the kit could be a light bulb extractor and that light bulb extractor could be any one of a suction cup tool, a spring-loaded friction removal tool, or a broken bulb removal tool.

### BRIEF DESCRIPTION OF FIGURES

FIG. 1 is a perspective assembled view of an exemplary embodiment of an adapter with a removal tool and a threaded pole.

FIG. 2 is an exploded perspective view of an exemplary embodiment of an adapter with a removal tool and a threaded pole.

FIG. 3 is a first perspective view of an exemplary embodiment of an adapter.

FIG. 4 is a second perspective view of an exemplary embodiment of an adapter.

FIG. 5A is a partially exploded side view of an internally threaded end of an exemplary embodiment of an adapter.

FIG. 5B is a partially assembled side view of an internally threaded end of an exemplary embodiment of an adapter.

FIG. 6A is a partially exploded side view of an attachment end of an exemplary embodiment of an adapter.

FIG. 6B is a partially assembled side view of an attachment end of an exemplary embodiment of an adapter.

FIG. 6C is a partially assembled side view of an attachment end of an exemplary embodiment of an adapter.

FIG. 7 is an axial cross section of an exemplary embodiment of an adapter.

FIG. 8 is a perspective view of an exemplary embodiment of an adapter with a removal tool and a threaded pole in use.

FIG. 9 is a perspective view of an exemplary embodiment of an adapter with a removal tool and a threaded pole in use.

FIG. 10 is a side view of a thread convertor.

FIG. 11 is a perspective view of a thread convertor.

FIG. 12 is a side view of an alternate embodiment of an adapter.

FIG. 13 is a side view of an alternate embodiment of an adapter.

FIG. 14 is a side view of an alternate embodiment of an adapter.

FIG. 15 is a side view of an alternate embodiment of an adapter.

FIG. 16 is a perspective view of a battery compartment cover.

FIG. 17 is a right perspective view of an assembled alternate embodiment of an adapter.

FIG. 18 is a left perspective view of an assembled alternate embodiment of an adapter.

FIG. 19 is a left view of an assembled alternate embodiment of an adapter.

FIG. 20 is an lower perspective view of an assembled alternate embodiment of an adapter focusing on the battery compartment.

FIG. 21 is a left perspective view of an alternate embodiment of an adapter.

FIG. 22 is a top perspective view of an alternate embodiment of an adapter.

FIG. 23 is a top perspective view of an alternate embodiment of an adapter.

FIG. 24 is left side view of an assembled alternate embodiment of an adapter.

FIG. 25 is a side view of a broken bulb removal tool.

FIG. 26 is a side view of a partially disassembled broken bulb removal tool.

FIG. 27 is a side view of a disassembled broken bulb removal tool.

FIG. 28 is a side view of a spring loaded removal tool.

FIG. 29 is a side view of an expanded spring loaded removal tool.

### DETAILED DESCRIPTION

Disclosed herein is an adapter for joining a removal tool to a threaded pole and a kit for joining a removal tool using the adapter to a threaded pole. As described herein, the following numbers refer to the following structures noted in the Figures.
10 refers to a threaded pole.
11 refers to an externally threaded end.
20 refers to a light bulb.
25 refers to a light socket.
50 refers to a removal tool.
55 refers to a removal tool stud.
56 refers to a removal tool stud hole.
65 refers to a suction cup tool.
100 refers to an adapter.
110 refers to a body.
120 refers to an internally threaded end.
121 refers to a first flat outer surface.
122 refers to a second flat outer surface.
125 refers to a threaded hole.
130 refers to an attachment end.
135 refers to a center hole.
140 refers to a spool.
141 refers to a string.
142 refers to a string first end.
143 refers to a string second end.
150 refers to a catch slot.
200 refers to a lock mechanism.
210 refers to a lock screw.
300 refers to an unthreaded attachment lock.
310 refers to a locking hole.
320 refers to an attachment lock handle.
400 refers to a thread convertor.
410 refers to external threads.
420 refers to a coned end.
500 refers to a modified adapter.
510 refers to electric component box.
520 refers to a battery compartment.
521 refers to a screw hole.
522 refers to a switch hole.
523 refers to a switch.
525 refers to a battery compartment cover.
526 refers to a slot in the battery compartment cover.
527 refers to an electric component box wall.
528 refers to a battery compartment lead hole.
530 refers to a battery.
540 refers to light groove.
550 refers to a lighting element.
551 refers to light leads.
570 refers to a first circuit end.
580 refers to a second circuit end.
600 refers to a broken bulb removal tool.
610 refers to a broken bulb removal tool base.
615 refer to a broken bulb removal tool base mount.
620 refers to a first broken bulb removal tool piece.
630 refers to an intermediate broken bulb removal tool base.
635 refers to an intermediate broken bulb removal tool mount.
640 refers to the second broken bulb removal tool piece.
700 refers to a spring loaded removal tool.
710 refers to a spring loaded removal tool base.
720 refers to a flexible contoured finger.
730 refers to a rubber coating.
740 refers to a curled lip on the steel slat.
750 refers to a circular spring.

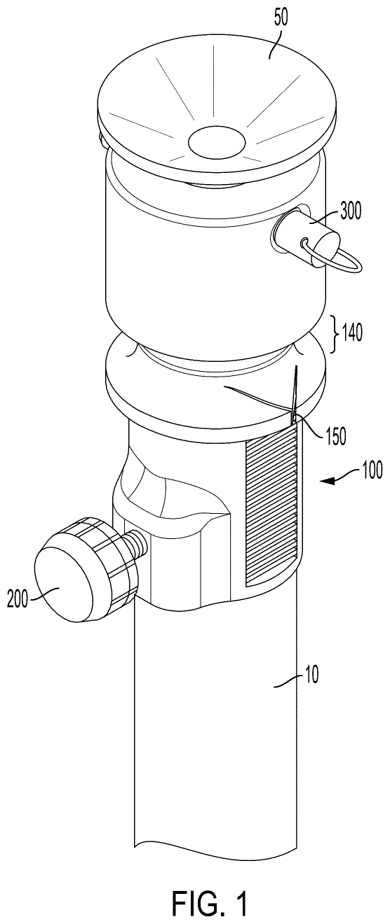

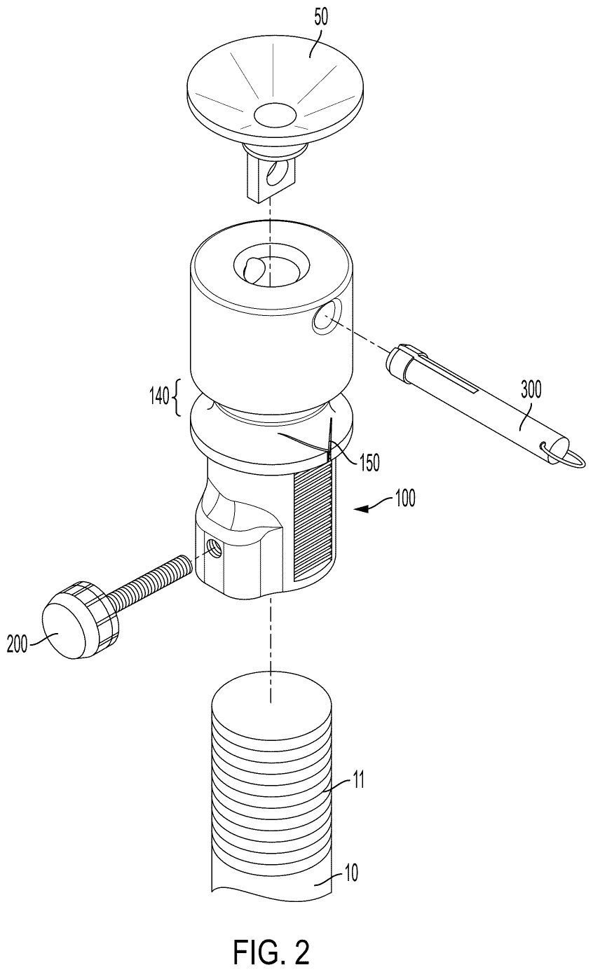

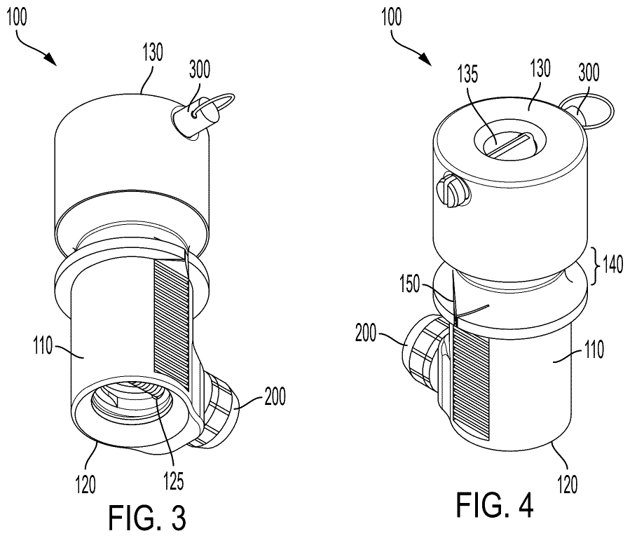

FIG. 1 illustrates a perspective view of an adapter (100) for joining a removal tool (50) to a threaded pole (10) in assembled form with FIG. 2 illustrating the adapter in exploded form. As shown in FIGS. 1 and 2, the threaded pole may include an externally threaded end (11) which mates with an internally threaded end ((120) as shown in FIG. 3) of the adapter. The threaded end may have standard ACME threads—such as ACME ⅞ H2 threads—such as those used on the pole for a broom, mop, or similar device. In some embodiments, the threaded pole may in fact be a pole used for a broom, mop, or similar device. A lock mechanism (200) may enter the internally threaded end, preferably perpendicular to the internally threaded hole, and abut against a surface of the externally threaded end of the threaded pole to prevent or reduce the risk of the externally threaded pole separating from the adapter during use.

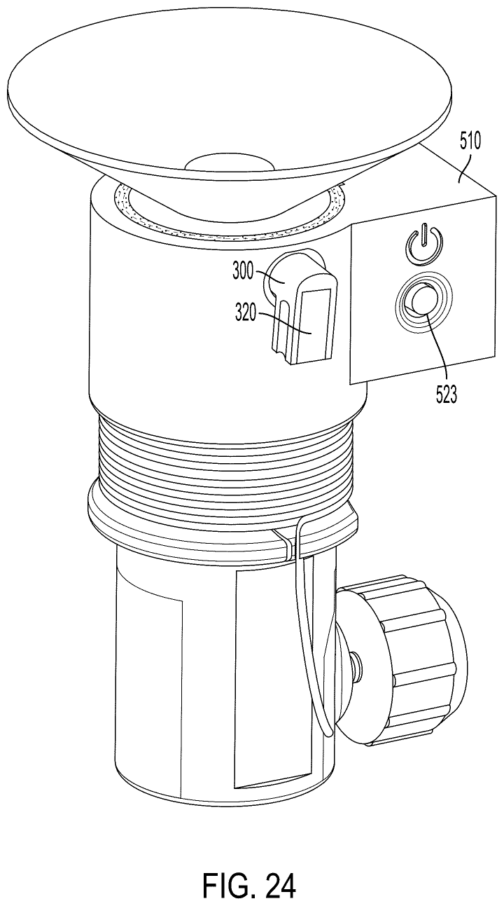

As further shown in FIGS. 1 and 2, the removal tool (50) mates with an attachment end ((130) as shown in FIG. 4) of the adapter. An attachment lock (300) may be configured to interact with the removal tool (50) when the removal tool is attached to the attachment end to prevent or reduce the risk of the removal tool separating from the adapter during use. The attachment lock may be threaded or unthreaded. It may also have an attachment lock handle (320). In some embodiments, As shown in FIG. 24, the attachment lock handle is “L” shaped to keep the attachment lock from passing through the lock hole.

FIG. 3 illustrates a perspective view of the adapter (100) shown from one end with FIG. 4 illustrating a perspective view of the adapter from the opposite end of that shown in FIG. 3. As shown in FIGS. 3 and 4, the adapter includes a body (110) having an internally threaded end (120) and an attachment end (130) opposite the internally threaded end. As shown in FIG. 3, the internally threaded end may be in the form of a threaded hole disposed into the adapter body originating from the internally threaded end. Preferably, the threaded hole will have a central axis which is substantially parallel to—and may be co-located with—the body central axis. Threads for the threaded hole may be configured to accept the externally threaded end ((11) as shown in FIG. 2) of the threaded pole ((10) as shown in FIG. 2) which may be in the form of a standard broom, mop, or other handle having ACME threads as described herein. In some embodiments, such as shown in FIG. 4, the attachment end may include a center hole (135) disposed into the adapter body originating from the attachment end. Preferably, the center hole will have a central axis which is substantially parallel to—and may be co-located with—the body central axis.

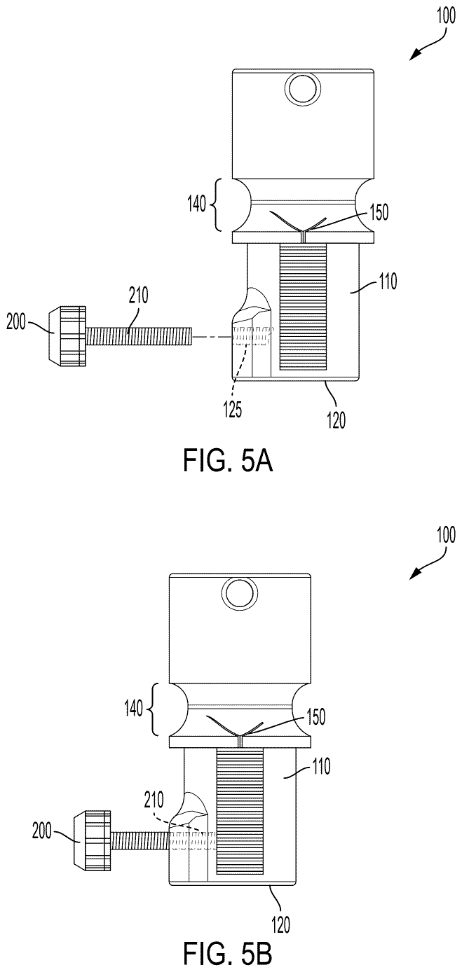

FIG. 5A illustrates the lock mechanism (200) disassembled from the body (110) of the adapter (100) with FIG. 5B illustrating the lock mechanism assembled to the body. In the embodiment shown in FIGS. 5A and 5B, the lock mechanism is a lock screw (210). The body includes a body sidewall with a threaded hole (125) passing therethrough and into the internally threaded end. The threaded hole being configured to threadably engage with the lock screw.

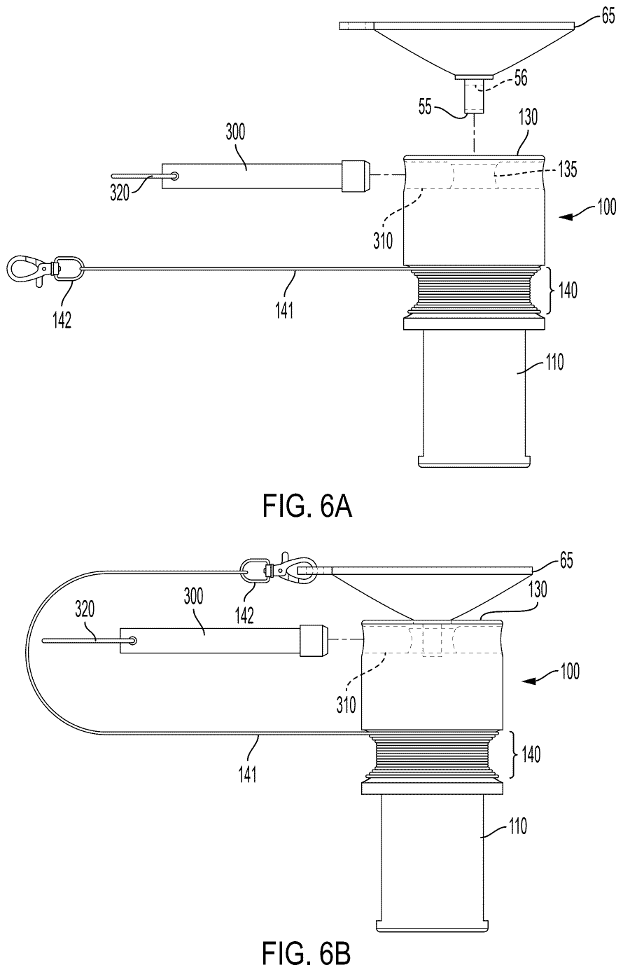

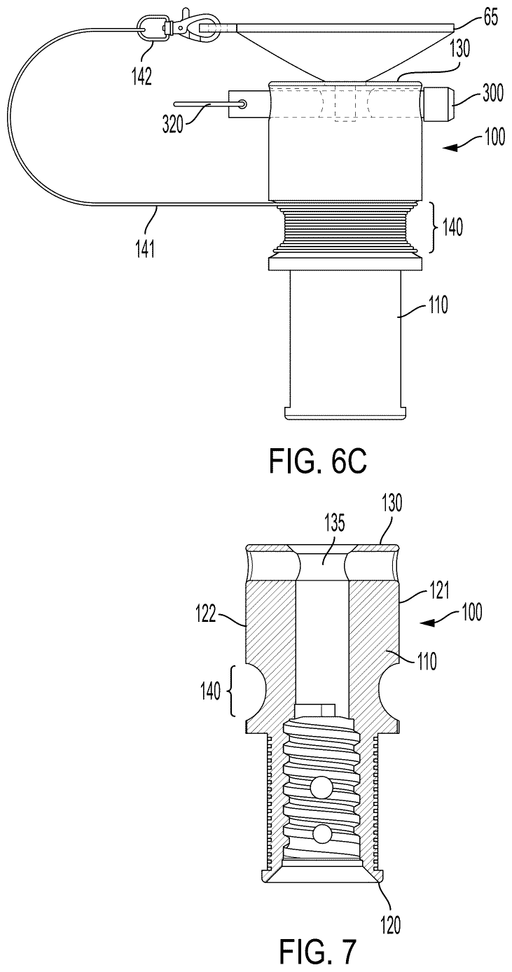

FIG. 6A illustrates the removal tool (50) and the unthreaded attachment lock (300) disassembled from the body (110) of the adapter (100) with FIG. 6B illustrating the removal tool assembled into the body, and FIG. 6C illustrating both the removal tool and the unthreaded attachment lock assembled into the body. In the embodiment shown in FIG. 6A, the attachment end (130) of the body includes the center hole (135) as shown in the FIG. 4 embodiment. The removal tool in this embodiment is a suction cup tool (65) having a removal tool stud (55) with a removal tool stud hole (56) disposed radially therethrough. The suction cup tool is attached to the adapter by first inserting the removal tool stud into the center hole as shown in FIG. 6B. Next, the unthreaded attachment lock is inserted through a locking hole (310) which preferably passes perpendicularly through the center hole as shown in FIG. 6C. As the unthreaded attachment lock passes into the locking hole, it also passes through the removal tool stud hole.

In the embodiment shown in FIGS. 6A through 6C, the unthreaded attachment lock (300) is in the form of a pin which passes part or all of the way through the locking hole (310) and into the removal tool stud hole (56) to secure the removal tool (50) to the attachment end (130). However, other embodiments of an attachment lock may exist. Examples of which include a depressible button configured to pass into at least a portion of the locking hole and into the stud hole, a spring interlock configured to pass into at least a portion of the locking hole and into the stud hole, and a magnet and pin system configured to pass into at least a portion of the locking hole and into the stud hole. Alternatively, the attachment lock may be a threaded attachment lock.

FIGS. 6A through 6C also illustrate an optional spool (140). When present, the spool may be disposed with a catch slot (150) located within the body (110) of the adapter (100) between the internally threaded end (120) and the attachment end (130). The spool houses a string (141). The string first end (142) may be configured to connect to a portion of the removal tool (50) as shown in FIG. 6B. The string second end (143) is loose, such that, when a user applies a force to the spool by pulling the string, a component of the force is in a direction substantially opposite the location of the removal tool, the force is transferred to the removal tool resulting in the removal tool releasing the device which the removal tool is holding. In the case of the suction type light removal tool, pulling the string releases the vacuum and detaches the cup from the bulb.

The string will also have a second end at the opposing end of the string first end. This second end is loose and used to unwind the spool and also for the operator to pull on when the string is unwound from the spool.

FIG. 7 illustrates a cross section view of the adapter (100) including the body (110) of the adapter. As shown in FIG. 7, the internally threaded end (120) of the body may include a first flat outer surface (121) and a second flat outer surface (122). The first flat outer surface opposing the second flat outer surface. The flat outer surfaces providing a gripping surface allowing a user to better grip the adapter for threading onto the externally threaded end ((11) as shown in FIG. 2) of the threaded pole ((10) as shown in FIG. 2) by hand or with the assistance of a device such as a pair of pliers. In certain embodiments, one or both of the first flat outer surface and/or the second flat outer surface may include a surface modification such as a series of dimples, slots, grooves, or the like which may further improve the user's grip. In some embodiments, the flat outer surfaces—with or without surface modifications—may be used to grip the adapter while the removal tool is operating on an object without the threaded pole being attached to the adapter.

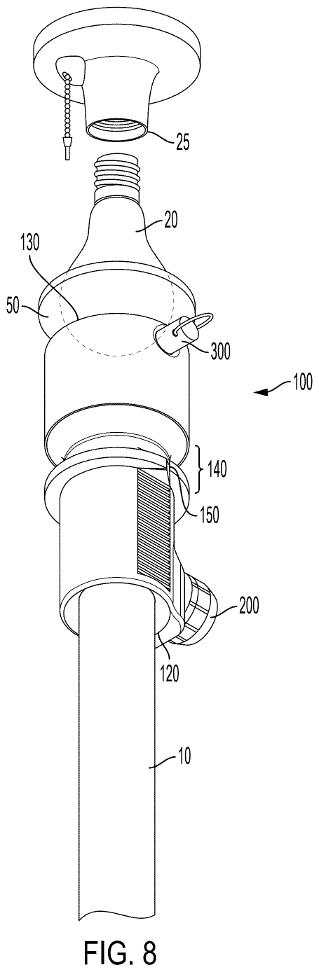

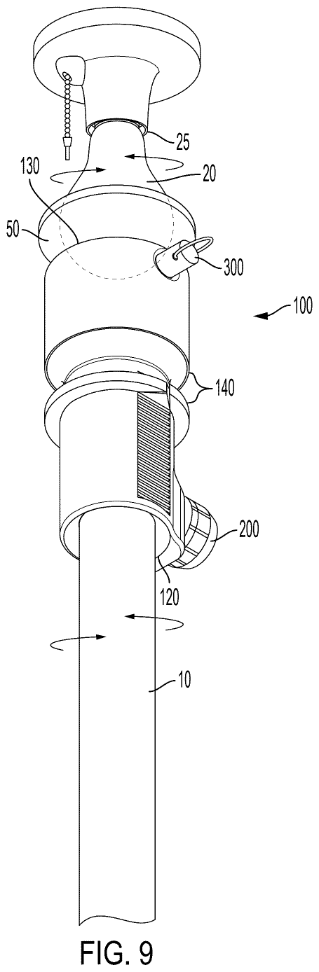

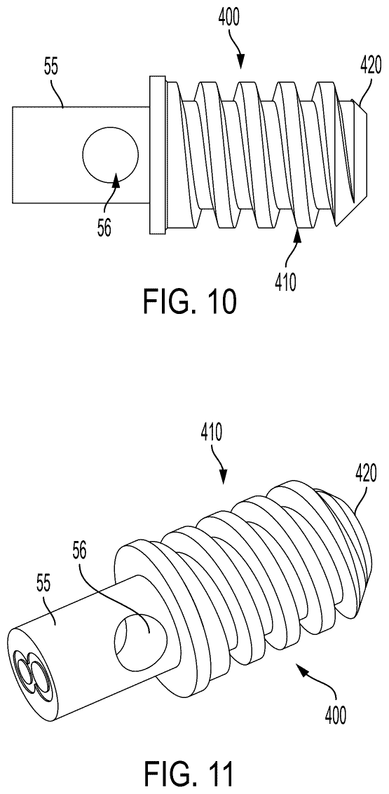

FIG. 8 and FIG. 9 illustrate the adapter “in use.” As shown in FIG. 8, the removal tool is in the form of a light bulb extractor which may be an extraction device such as a suction cup tool (65), a spring-loaded friction removal tool, and a broken bulb removal tool. A light bulb (20) is connected to the removal tool which has been secured to the attachment end (130) of the body (110) of the adapter (100) as described herein. The threaded pole (10) has been attached to the internally threaded end (120) of the body of the adapter as described herein. The light bulb is then extended towards a light socket (25) which does not have a light bulb disposed therein.

In FIG. 9, the light bulb (20) is aligned with and placed into the light socket (25) and twisted to thread the light bulb into the light socket to install the light bulb into the light socket. One will recognize that the configuration may be reversed by connecting the removal tool to a light bulb previously installed in the light socket and twisting in the opposite direction to remove the light bulb from the light socket. If assistance is needed to remove the removal tool from the light bulb, a force may be applied to the string—which transfers the force to the removal tool as described herein to release the removal tool from the light bulb.

The adapter for joining a removal tool to a threaded pole may also be provided as part of a kit for attaching a tool to a threaded pole. The kit will have at least one tool, and preferably two or more tools. The kit will preferably be provided with an adapter (100) of any type described herein and illustrated in the Figures, at least one lock mechanism (200) of any type described herein and illustrated in the Figures, and at least one unthreaded attachment lock (300) of any type described herein and illustrated in the Figures. Optionally, the kit may also include a threaded pole (10) of any type described herein and illustrated in the Figures, and/or a removal tool (50) of any type described herein and illustrated in the Figures.

One of ordinary skill will realize the adapter may be unthreaded and a pole without threads or threads could be inserted into end corresponding to the internally threaded end. The pole would have to be fixed in place so that, when turned, the adapter would turn as well. This could be done via a pin passing through a hole in the pole, for example.

Optionally, the kit may contain a thread convertor (400) as shown in FIGS. 10 and 11. This convertor is an extension tool (400) which allows the user to add external threads (410) to the end of a hollow pole which is unthreaded. The external threads may have a cone shaped end (420) to aid in placing the threads into the internally threaded component of the adapter.

As shown in FIGS. 17-23 the adapter may include a lighting element which may be in the form of one or more light emitting diodes (LEDs) preferably located within or connected to an exterior surface of the attachment end (130).

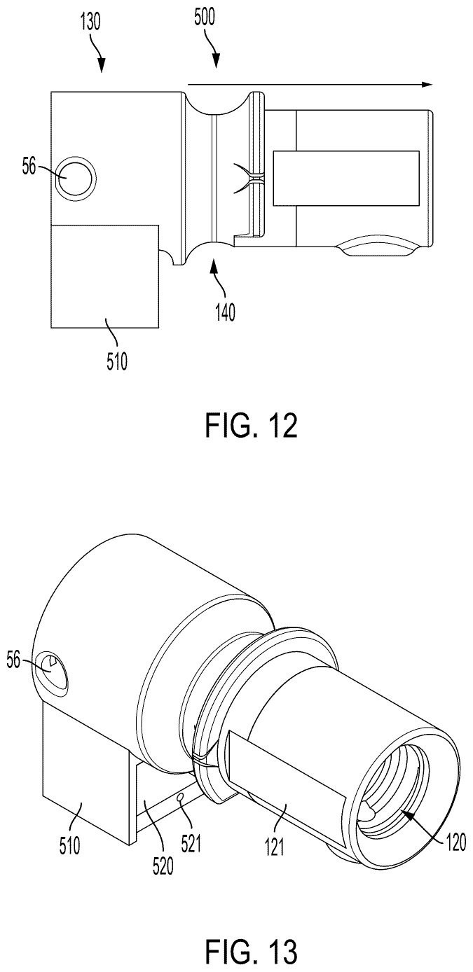

The lighting element may be electrically connected to a power supply—which may be in the form of a battery (530) located within the body (110) of the adapter (100). As shown in FIGS. 12-23, there is an electric component box (510) defining a battery compartment (520). The batteries are held in the electric component box by a battery compartment cover (525).

A switch (523), button or similar device located on an exterior surface of the body or attached to the threaded pole (10) may be used to turn the lighting element on or off by closing and opening a circuit between the lighting element and the power supply.

FIGS. 12 and 13 are side and perspective views of an embodiment of the adapter with the light. The attachment end (130) has an electric component box (510) with a battery compartment (520). A screw hole (521) may exist in the wall (527) of the electric component box.

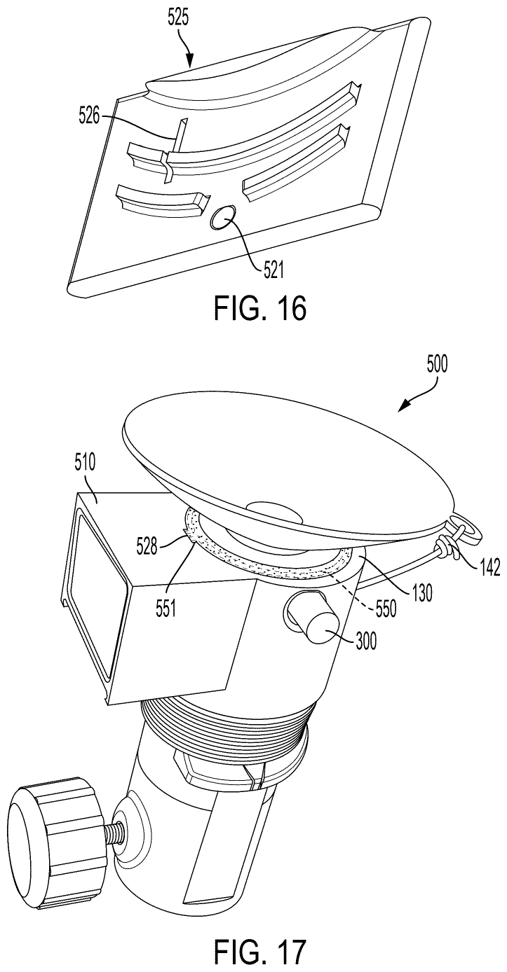

FIG. 16 shows the battery compartment cover (525). The battery compartment cover has a screw hole (521) through which the screw passes and is threaded into the screw hole in the electric component box wall.

The battery compartment cover may also have a slot (526) passing through the cover. The adapter is shipped with a battery disconnect tab or battery isolator tab, not shown. The battery disconnect tab is a piece of non-conductive material passing through the slot and between two batteries or a battery and a lead, thus keeping the circuit open. The operator will remove the non-conductive material by pulling it through the slot and closing the circuit (assuming the switch is in the on position).

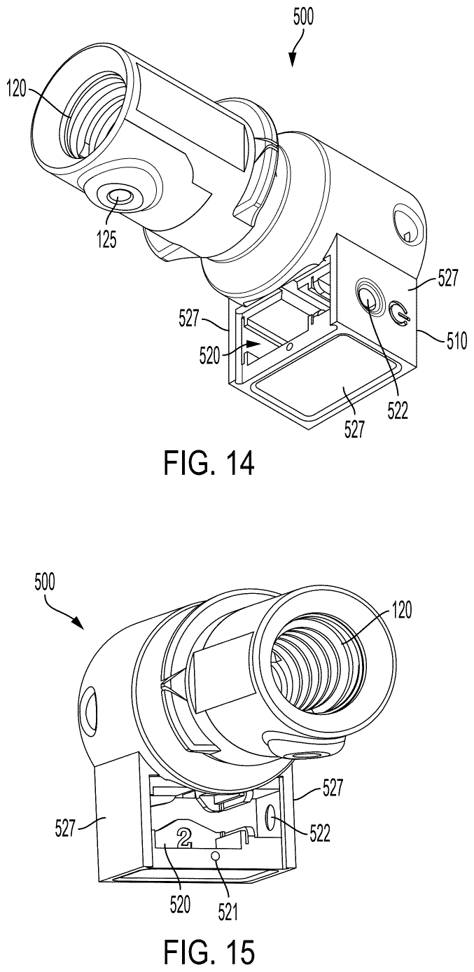

FIGS. 14 and 15 show the inside of the electric component box (510) encompassing the battery compartment (520). There is a switch hole (522) passing through an electric component box wall (527).

FIG. 17 shows the adapter with the electric component box and the lighting element. The lighting element (550) in this example is a string of LED lights circling the end of the adapter (130) and placed into a light groove (540) in the adapter. This LED string has leads (551) going into the battery compartment through a hole in the electric component box wall (528). The LED string sits in a light groove (540) that encircles the top of the adapter.

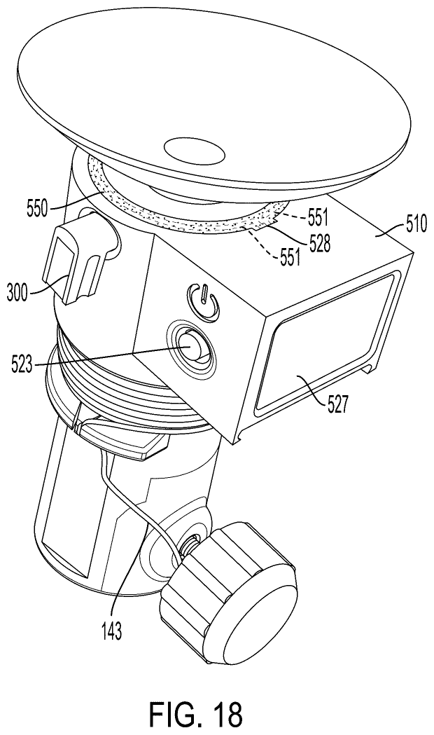

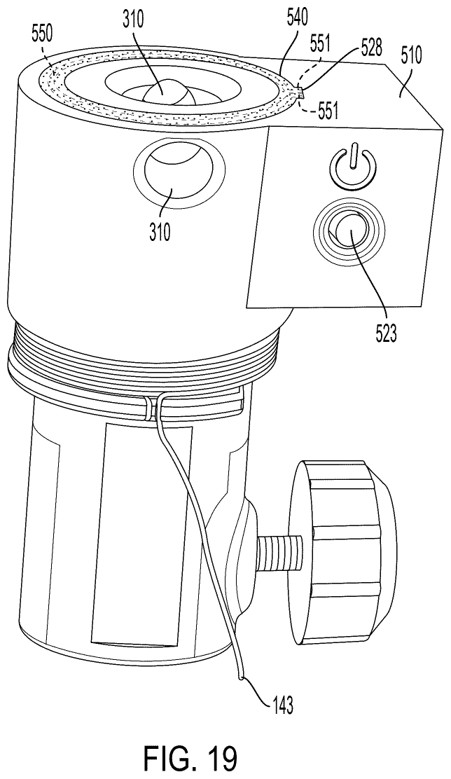

FIGS. 18 and 19 shows the adapter with the switch (523) on the opposite side of the electric component box in FIG. 17. The switch in this case is a push button switch.

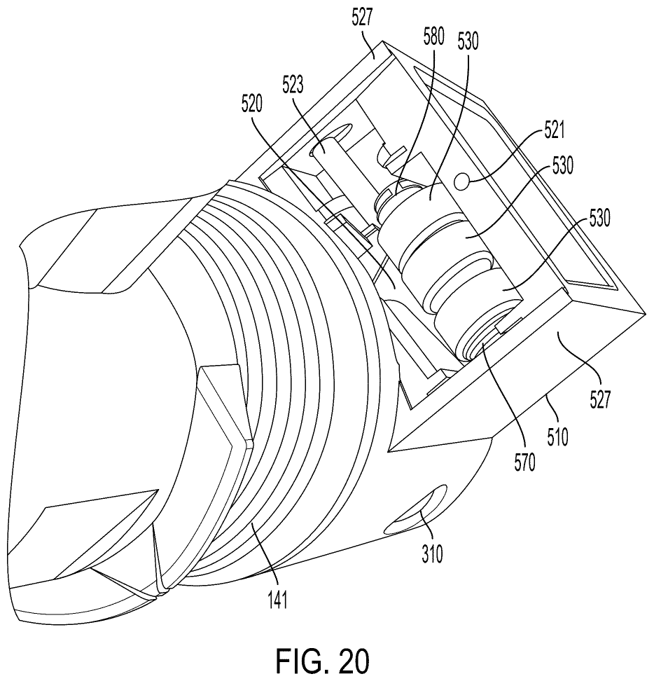

FIG. 20 shows the battery compartment with three batteries (530) aligned in series, in this case button batteries. Also shown is the switch (523), the first circuit end (570), and the second circuit end (580). Each of these circuit ends are attached to a light lead. In this embodiment, the circuit ends are pressed up against the ends of the series of batteries closing the circuit and causing the light to emit light when the switch is in the on position.

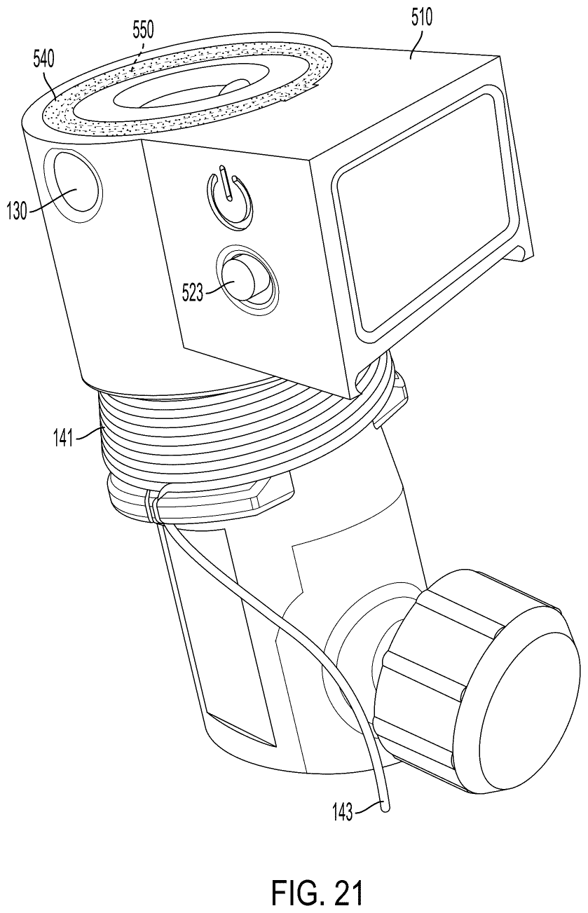

FIG. 21 is a perspective view of the light groove (540) and lighting element (550) at the adapter end (130).

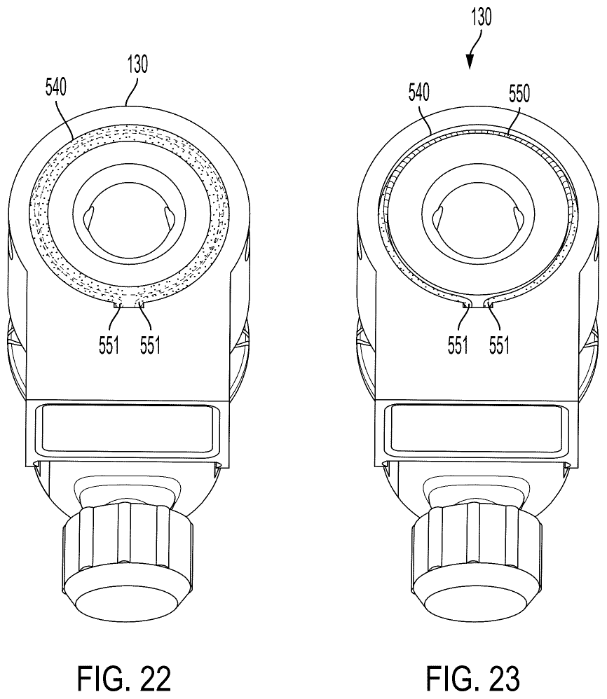

FIGS. 22 and 23 are top views of the adapter end with FIG. 22 showing the light on and FIG. 23 showing the light off making the string of LED diodes more apparent.

FIG. 24 shows the switch depressed with the light on.

It is preferred that at least a portion of the light emitted from the lighting element is directed away from the adapter to illuminate an object that the removal tool is acting on while advancing the removal tool towards said object and while the removal tool is acting on said object.

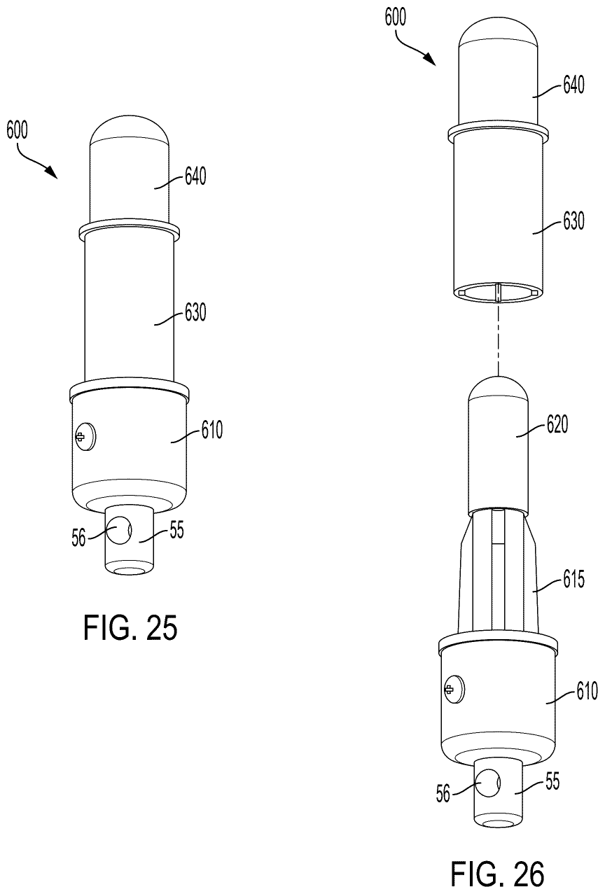

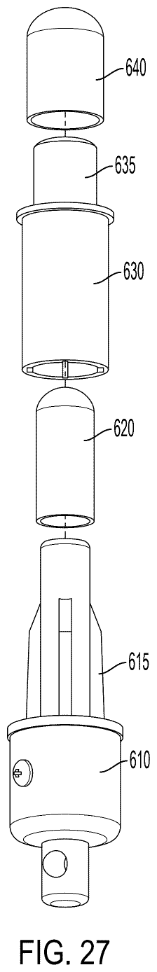

FIGS. 25, 26 and 27 show a broken light bulb tool (600) to remove broken lights. As shown in the Figures, there is a broken bulb removal tool base (610) having a broken bulb removal tool base mount (615) to which a first removal piece is mounted. There is an intermediate base (630) which fits over the first removal piece and has an intermediate mount (635) over which the second removal piece slips. This allows the user to have different sizes of removal pieces.

The removal piece is made of flexible rubber or plastic with a hole or slits at the rounded edge that will open up when pressed against the broken bulb. The bulb is then rotated to remove the male end of the bulb from the socket.

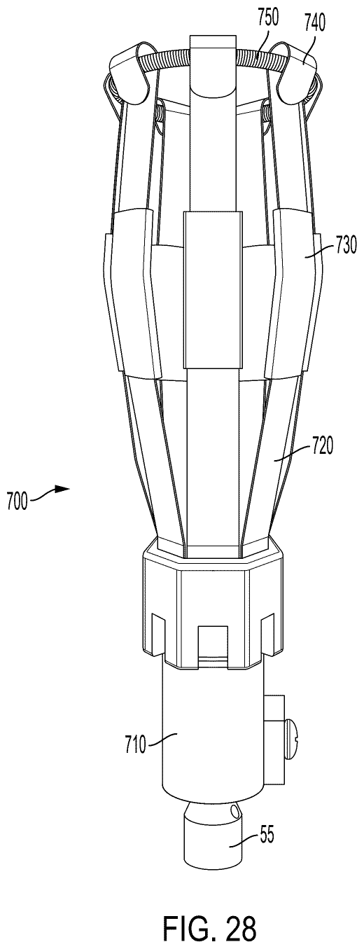

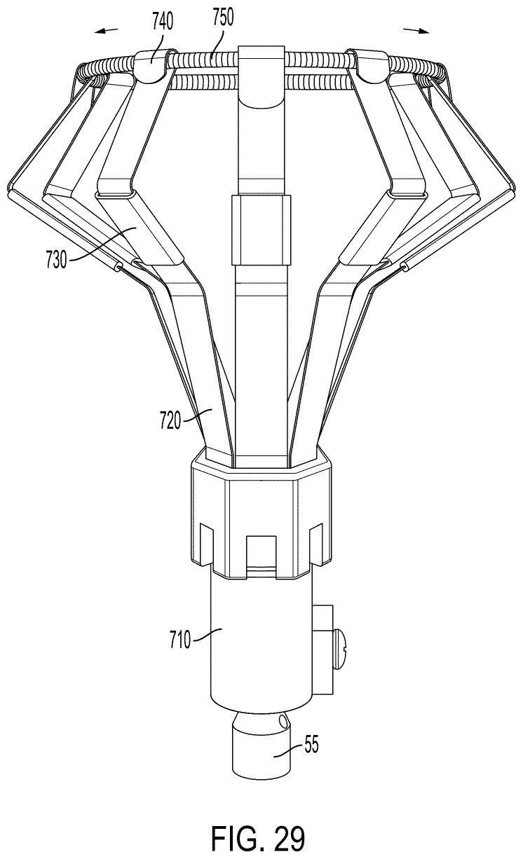

The removal tool may be in the form of a spring-loaded removal tool (700) as shown in FIGS. 28 and 29. A spring loaded removal tool—like the suction cup tool—may include a stud having a stud hole through which the unthreaded attachment lock (300) may pass to secure the removal tool to the attachment end (130). The spring loaded removal tool may then include a plurality of flexible contoured fingers (720) extending from an end opposite the removal tool stud (55) called a spring removal tool base (710) which terminate at a spring loaded end. The spring loaded end comprises a flexible member such as a circular spring (750) which links the terminal ends of the flexible contoured fingers to one another. There is typically a curled lip (740) on the flexible finger which encompasses a circular spring (750).

The flexible fingers may have a portion of them coated with a rubber or plastic coating (730) to provide friction against the bulb and protect the bulb.

Once the terminal ends are connected by the flexible member, the plurality of flexible members may form a substantially circular shape, like a cup. The flexible member allowing the terminal ends of one or more of the flexible contour fingers to extend outwardly upon application of a force applied by an object pressing against the terminal ends in a direction substantially parallel to the central axis of the spring loaded friction cup to allow the object to extend into and out of the spring loaded friction cup. In any event, it is preferred that the removal tool include a stud with a stud hole disposed radially therethrough allowing the removal tool to securely connect to the attachment end as described herein. When depressed against a bulb the spring will deform and the bulb will fit into the circular, stretched spring as shown in FIG. 29.

The various embodiments of the adapter (100) disclosed herein may be manufactured using any number of different materials and any number of different manufacturing techniques. Preferably, the adapter will be manufactured of a rigid plastic material. Such materials include PolyLacticAcid (PLA) based polymers, acrylonitrile butadiene styrene (ABS), polyethylene (PE), nylon, and polyesters. However, embodiments may exist in which the adapter is manufactured of a metal material such as steel, stainless steel, aluminum, or the like. Other embodiments may exist in which the adapter is manufactured of wood. Manufacturing techniques may include cutting, bending, grinding, welding, casting, forging, injection molding, and the like.

While the adapter has been described as having one or more exemplary designs, the present adapter may be further modified within the spirit and scope of this disclosure. This application is therefore intended to cover any variations, uses, and adaptations of the adapter using its general principles.

It is conceived that the adapter will be provided as part of a kit with at least one tool, if not two or three tools and optionally, the thread convertor.

What is claimed is:

1. An adapter (100) for joining a tool (50) having a tool stud (55) and a tool stud hole (56) to a threaded pole (10), said adapter comprising:
a body (110) having
an internally threaded end (120);
an attachment end (130) having a center hole (135) opposite the internally threaded end;
a lock mechanism (200) entering the internally threaded end; and
an attachment lock (300) configured to interact with the tool stud and the attachment end when the tool stud is inserted into the center hole.

2. The adapter of claim 1, wherein the attachment end comprises a lighting element (550) electrically connected to a power supply (530), said lighting element is configured to turn on when a circuit between the lighting element and the power supply is closed by a switch (523).

3. The adapter of claim 1, further comprising a locking hole (310) passing through the center hole, and wherein the attachment lock is selected from the group consisting of a pin configured to pass into the locking hole, a depressible button configured to pass into at least a portion of the locking hole, a spring interlock configured to pass into at least a portion of the locking hole, and a magnet and pin system configured to pass into at least a portion of the locking hole.

4. The adapter of claim 1, further comprising a spool (140) located between the internally threaded end and the attachment end, and a string (141) having a string first end (142) configured to connect to a portion of the tool.

5. The adapter of claim 1, wherein the internally threaded end of the body includes a first flat outer surface (121) and a second flat outer surface (122) with the first flat outer surface opposing the second flat outer surface.

6. The adapter of claim 1, wherein the lock mechanism comprises a lock screw (210) configured to pass into a threaded hole (125) in a body sidewall at the internally threaded end.

7. A kit for attaching a tool (50) to a threaded pole (10), said kit comprising:
an adapter (100) comprising a body (110) having
an internally threaded end (120),
an attachment end (130) opposite the internally threaded end and comprising a center hole (135),
a lock mechanism (200) for the internally threaded end,
an attachment lock (300) for the attachment end;
the tool having a tool stud (55) with a tool stud hole (56); and
wherein said attachment lock is configured to interact with the tool stud when the tool stud is inserted into the center hole.

8. The kit of claim 7, the adapter further comprising a lighting element (550) at the attachment end that is electrically connected to a power supply (530), with said lighting element configured to turn on when a circuit between the lighting element and the power supply is closed by a switch (523).

9. The kit of claim 7, further comprising a locking hole (310) passing through the center hole, and wherein the attachment lock is selected from the group consisting of a pin configured to pass into the locking hole, a depressible button configured to pass into at least a portion of the locking hole, a spring interlock configured to pass into at least a portion of the locking hole, and a magnet and pin system configured to pass into at least a portion of the locking hole.

10. The kit of claim 8, further comprising a locking hole (310) passing through the center hole, and wherein the at least one attachment lock is selected from the group consisting of a pin configured to pass into the locking hole, a depressible button configured to pass into at least a portion of the locking hole, a spring interlock configured to pass into at least a portion of the locking hole, and a magnet and pin system configured to pass into at least a portion of the locking hole.

11. The kit of claim 7, wherein the adapter further comprises a spool (140) that houses a string (141) located between the internally threaded end and the attachment end of the adapter.

12. The kit of claim 11, wherein a string first end (142) is configured to connect to a portion of the tool.

13. The kit of claim 8, wherein the adapter further comprises a spool (140) that houses a string (141) located between the internally threaded end and the attachment end of the adapter.

14. The kit of claim 13, wherein a string first end (142) is configured to connect to a portion of the tool.

15. The kit of claim 7, wherein the lock mechanism comprises a lock screw (210) configured to pass into a threaded hole (125) in a body sidewall at the internally threaded end.

16. The kit of claim 8, wherein the at least one lock mechanism comprises a lock screw (210) configured to pass into a threaded hole (125) in a body sidewall at the internally threaded end.

17. The kit of claim 7, wherein the tool is a light bulb extractor.

18. The kit of claim 17, wherein the light bulb extractor is selected from the group consisting of a suction cup tool (65), a spring-loaded friction removal tool (700), and a broken bulb removal tool (600).

19. The kit of claim 8, wherein the tool is a light bulb extractor.

20. The kit of claim 19, wherein the light bulb extractor is selected from the group consisting of a suction cup tool (65), a spring-loaded friction removal tool (700), and a broken bulb removal tool (600).
